(19) United States
(12) Patent Application Publication
(10) Pub. No.: US 2004/0227611 A1
(43) Pub. Date: Nov. 18, 2004

(54) Over-current protection apparatus with high voltage endurance

(76) Inventors: Edward F. Chu, Taipei (TW); Yun-Ching Ma, Pingtung City (TW); Tong-Cheng Tsai, Tainan City (TW)

Correspondence Address: Harold V. Stotland, Seyfarth Shaw, 42nd Floor, 55 East Monroe Street, Chicago, IL, 60603-5803, US

(21) Appl. No.: 10/758,807

(22) Filed: Jan. 16, 2004

Related U.S. Application Data
(60) Provisional application No. 60/470,548, filed on May 14, 2003.

(51) Int. Cl. H01H 85/06

(52) U.S. Cl. 337/167; 361/159

(57) ABSTRACT

An over-current protection apparatus with high voltage endurance comprises a first electrode layer, a second electrode layer and a ceramic current-sensitive layer, where both the first and second electrode layers are continuous and uniform to enhance electrical and thermal conductivities thereof. The ceramic current-sensitive layer is sandwiched between the first and second electrode layers, and is essentially composed of basic matrix, dopants, conductors and sintering material. The resistance of the over-current protection apparatus with high voltage endurance is less than 10 ohms before being tripped, and the resistance-jumping ratio is less than 1.3.

### RELATED APPLICATION

This application claims benefit of the filing of copending U.S. Provisional Application No. 60/470,548, filed May 14, 2003.

### BACKGROUND OF THE INVENTION

(A) Field of the Invention

The present invention is related to an over-current protection apparatus, more particularly, to an over-current protection apparatus with high voltage endurance.

(B) Description of the Related Art

The resistance of a positive temperature coefficient (PTC) conductive material is sensitive to temperature variation, and can be kept extremely low at normal operation due to its low sensitivity to temperature variation so that the circuit can operate normally. However, if an over-current or an over-temperature event occurs, the resistance will immediately increase to a high resistance state (e.g., above 10⁴ ohm.) Therefore, the over-current will be reversely eliminated and the objective to protect the circuit device can be achieved.

PTC devices can be roughly categorized into a Polymer Positive Temperature Coefficient (PPTC) device and a Ceramic Positive Temperature Coefficient (CPTC). A conventional PPTC device cannot easily regain the original resistance after being tripped, i.e., worse resistance hysteresis behavior, and cannot endure high voltages. A CPTC device normally has the advantage of high voltage endurance, and its resistance is closer to the original value after recovery. However, the worse electrical conductivity of the CPTC device due to the inherent high normal resistance limits the applications for over-current protection.

As usual, the electrodes of CPTC device are made by sintering silver powders; however, the sintered silver powders are not quite dense, inducing non-uniform electrical and heat conductivities. Further, the bonding between the silver powders is not strong, so the sintered silver powders may be partially melted during the following soldering. Therefore, the over-current protection apparatus using silver powders as the material of electrodes has higher normal resistance, and thus the number of applications is rather limited.

Nowadays, telecommunications have become an essential part of human lives; for example, telephones, networking and wireless communications all rely on the telecom systems for signal transmission. However, a telecom system usually contains electrical conductors, e.g., metal, to transmit signals so that they may encounter lightning strike. Accordingly, because the PPTC device cannot withstand high voltages, it is inadequate to use it in such high voltage environments. However, owing to the high normal resistance, it is not adequate to employ the CPTC device in the telecom system as an over-current protection device either.

In other words, it is necessary to provide a resetable over-current protection apparatus with high voltage endurance and low normal resistance.

### SUMMARY OF THE INVENTION

The objective of the present invention is to provide an over-current protection apparatus with high voltage endurance, which has the features of low normal resistance and high voltage endurance, so as to be implemented in high voltage applications.

The over-current protection apparatus with high voltage endurance of the present invention comprises a first electrode layer, a second electrode layer and a ceramic current-sensitive layer, where both the first and second electrode layers are continuous and uniform in order to enhance electrical and thermal conductivities thereof. The ceramic current-sensitive layer is interposed between the first and second electrode layers, and is essentially composed of basic matrix, dopants, conductors and sintering material. The resistance of the over-current protection apparatus is less than 10 ohms prior to being tripped, and the resistance-jumping ratio is less than 1.3.

Such ceramic current-sensitive layer may select barium titanate (BaTiO₃) as the base matrix; strontium (Sr), lead (Pb), beryllium (Be), calcium (Ca) or selenium (Se) as the dopants; the carbides or silicide of titanium (Ti), zirconium (Zr), niobium (Nb) or tantalum (Ta) as the conductors, and silicon (Si), Ti or germanium (Ge) as the sintering material.

The over-current protection apparatus in accordance with the present invention can withstand a voltage of approximately 800 volts and a current of approximately 50 amps without being burned. Therefore, the over-current protection apparatus is ideal to be implemented in high voltage applications.

### BRIEF DESCRIPTION OF THE DRAWINGS

FIG. 1 illustrates an over-current protection apparatus with high voltage endurance of the present invention; and

FIG. 2 illustrates the manufacturing flow chart of the over-current protection apparatus with high voltage endurance of the present invention.

### DETAILED DESCRIPTION OF THE INVENTION

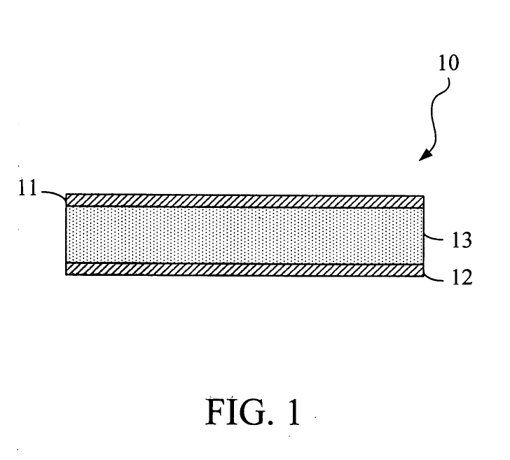

FIG. 1 illustrates an over-current protection apparatus in accordance with the present invention. An over-current protection apparatus 10 with high voltage endurance comprises a first electrode layer 11, a second electrode layer 12 and a ceramic current-sensitive layer 13. Both the first and second electrode layers 11, 12 are continuous and uniform, and can be made of nickel-phosphorus (Ni—P) alloy, silver (Ag), aluminum (Al), gold (Au), gallium-iodine (Ga—I) alloy and zinc-silver (Zn—Ag) alloy. The ceramic current-sensitive layer 13 can be made of CPTC material, and is sandwiched between the first electrode layer 11 and the second electrode layer 12. In this embodiment, the over-current protection apparatus 10 is of a thickness less than 2.5 mm and an area less than 200mm².

Table 1 exemplifies the materials of the first and second electrode layers 11, 12 and deposition methods thereof to be overlaid on the ceramic current-sensitive layer 13. By employing the materials listed in Table 1 and the corresponding deposition methods, the first and second electrode layers 11 and 12 will be uniform and continuous, so as to acquire superior electrical and thermal conductivities. As a result, the resistance of the over-current protection apparatus 10 can be decreased.

TABLE 1

| Electrode Materials | Deposition Methods |
|---|---|
| Ni—P Alloy, Ag | Electroplating |
| Al, Au | Plasma or Flame Sputtering |
| Ga—I Alloy | Supersonic Soldering |
| Zn—Ag Alloy | Thick Film Printing |

The ceramic current-sensitive layer 13 is essentially composed of basic matrix, dopants, conductors and sintering material, wherein the dopants are used for adjusting the Curie point, the conductors are used for electrical conduction, and the sintering material is used for sintering temperature adjustment. In this embodiment, the ceramic current-sensitive layer 13 selects BaTiO₃ as the basic matrix; Sr, Pb, Be, Ca or Se as the dopants; carbides or silicides of Ti, Zr, Nb and Ta as the conductors; and Si, Ti or Ge as the sintering material, as summarized in Table 2.

TABLE 2

| Materials | Chemical Composition |
|---|---|
| Basic Matrix | BaTiO₃ |
| Dopants | Sr, Pb, Be, Ca, Se |
| Conductors | Carbide or Silicide of Ti, Zr, Nb, Ta |
| Sintering Materials | Si, Ti or Ge |

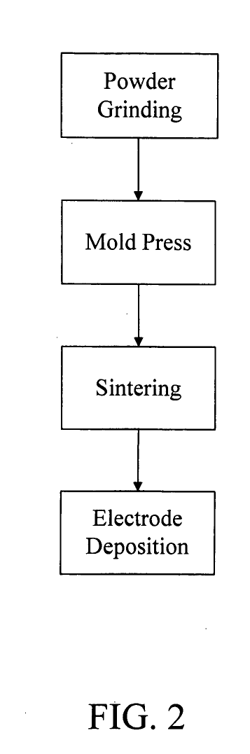

FIG. 2 illustrates the manufacturing flow of the over-current protection apparatus 10. First, material selected from Table 2 is ground into powders and pressed in a mold. Secondly, the material is sintered to form the ceramic current-sensitive material 13, and then the first and second electrode layers 11, 12 are deposited thereon by a method listed in Table 1 to form the over-current protection apparatus 10.

The over-current protection apparatus 10 does not burn while being tested under the electricity up to 600 volts and 50 amps. When current increases to 60 amps, only cracks occur in the ceramic current-sensitive layer 13, but no burn occurs on the over-current protection apparatus 10. In contrast, under the same testing conditions, i.e., 600 volts and 50 amps, the over-current protection apparatus of PPTC has burned out. Obviously, the over-current protection apparatus 10 in accordance with the present invention can work under high voltages and high currents without burn, and thus it is fairly adequate to implement in high voltage applications. Further, the over-current protection apparatus 10 can function normally and has no burn when the applied voltage increases up to 800 volts and the current is up to 50 amps.

Table 3 shows the test results of the resistance-jumping ratios of the over-current protection apparatus 10 using CPTC and the conventional over-current protection apparatus using PPTC. If the resistance-jumping ratio is equivalent to 1, the over-current protection apparatus can return to have the original resistance value after being tripped and recovered. If the resistance-jumping ratio is equivalent to 1.1, the resistance of the over-current protection apparatus after trip and recovery becomes 1.1 times the original value. The test conditions in Table 3 are under BELLCORE 1089 specification, in which the over-current protection apparatus 10 is tested under 600 volts associated with various current conditions:(1) flowing a current of one amp for one second and repeating it sixty times; (2) flowing a current of 2.2 amps for one second; and (3) flowing a current of three amps for one second, and the corresponding resistance-jumping ratios tested in the above various conditions are 0.92, 1.047 and 1.158, respectively, and are all less than 1.3. Under the same test conditions, the over-current protection apparatus using PPTC has the resistance-jumping ratios of 1.008, 1.479 and 1.156, respectively. Accordingly, the over-current protection apparatus in accordance with the present invention can tremendously decrease the resistance-jumping ratios.

TABLE 3

| | Test conditions | | |
|---|---|---|---|
| | 600 V/1 A | 600 V/2.2 A | 600 V/3 A |
| Apparatus | 1 sec/60 times | 1 sec/1 time | 1 sec/1 time |
| Apparatus using CPTC of | 0.92 | 1.047 | 1.158 |
| the present invention | | | |
| Apparatus using PPTC | 1.008 | 1.479 | 1.516 |

The over-current protection apparatus 10 has a normal resistance between 6-10 ohms, and the Curie point is less than 85° C. Apparently, besides the high voltage endurance, the over-current protection apparatus 10 in accordance with the present invention has superior resistance recovery performance and low normal resistance, so it is fairly adequate to be used in high voltage applications such as telecommunications or the like.

The above-described embodiments of the present invention are intended to be illustrative only. Numerous alternative embodiments may be devised by those skilled in the art without departing from the scope of the following claims.

What is claimed is

1. An over-current protection apparatus with high voltage endurance, comprising:
a first electrode layer being continuous and uniform;
a second electrode layer being continuous and uniform; and
a ceramic current-sensitive layer sandwiched between the first and second electrode layers and comprising a basic matrix, dopants, conductors and sintering materials;
the over-current protection apparatus having the following features:
(a) a normal resistance of less than 10 ohms;
(b) a resistance-jumping ratio of less than 1.3; and
(c) a thickness of less than 2.5 mm.

2. The over-current protection apparatus with high voltage endurance in accordance with claim 1, wherein the area of the over-current protection apparatus is less than 200mm².

3. The over-current protection apparatus with high voltage endurance in accordance with claim 1, wherein the Curie point of the over-current protection apparatus is less than 85° C.

4. The over-current protection apparatus with high voltage endurance in accordance with claim 1, wherein the basic matrix is composed of barium titanate.

5. The over-current protection apparatus with high voltage endurance in accordance with claim 1, wherein the dopants are selected from the group substantially consisting of strontium, lead, beryllium, calcium and selenium.

6. The over-current protection apparatus with high voltage endurance in accordance with claim 1, wherein the conductors are selected from the group substantially consisting of carbides of titanium, zirconium, niobium and tantalum.

7. The over-current protection apparatus with high voltage endurance in accordance with claim 1, wherein the conductors are selected from the group substantially consisting of suicides of titanium, zirconium, niobium and tantalum.

8. The over-current protection apparatus with high voltage endurance in accordance with claim 1, wherein the sintering material is selected from the group substantially consisting of silicon, titanium and germanium.

9. The over-current protection apparatus with high voltage endurance in accordance with claim 1, wherein the first and second electrode layers are selected from the group substantially consisting of nickel-phosphorus alloy, silver, aluminum, gold, gallium-iodine alloy and zinc-silver alloy.

10. The over-current protection apparatus with high voltage endurance in accordance with claim 1, wherein the first and second electrode layers are made by electroplating, plasma sputtering, flame sputtering, supersonic soldering or thick film printing.
